(19) United States
(12) Patent Application Publication
(10) Pub. No.: US 2021/0380840 A1
(43) Pub. Date: Dec. 9, 2021

(54) THERMAL INSULATION COATING

(71) Applicant: SCG CHEMICALS CO., LTD, Bangkok (TH)

(72) Inventors: Noppakun SANPO, Rayong (TH); Koichi FUKUDA, Tokyo (JP); Jaturong JITPUTTI, Bangkok (TH); Darapond TRIAMPO, Bangkok (TH); Supan YODYINGYONG, Nakorn Pathom (TH)

(73) Assignee: SCG CHEMICALS CO., LTD, Bangkok (TH)

(21) Appl. No.: 17/283,704

(22) PCT Filed: Oct. 8, 2019
(86) PCT No.: PCT/TH2019/000046

§ 371 Date: Apr. 8, 2021

(30) Foreign Application Priority Data
Oct. 9, 2018 (TH) 1801006300

(51) Int. Cl. C09D 183/00; C09D 133/02; C09D 7/61; C09D 5/02; C08K 7/20

(52) U.S. Cl. CPC C09D 183/00; C09D 133/02; C08K 7/20; C09D 5/022; C09D 5/024; C09D 7/61

(57) ABSTRACT

The present invention relates to a thermal insulation coating comprising at least two layers of coating, wherein a composition of the first layer comprises a silicone-based binder and a hollow glass microsphere, a composition of the second layer comprises an acrylic polymer and a hollow glass microsphere. Said thermal insulation coating is suitable for high-temperature applications, capable of adhering to a surface effectively, environmentally friendly, as well as providing high thermal reduction and low thermal conductivity.

### TECHNICAL FIELD

Chemistry related to a thermal insulation coating

### BACKGROUND OF THE INVENTION

A thermal insulation coating is a material commonly used for preventing heat transfer and for energy-saving. There are two types of thermal insulation coatings: 1) a thermal insulation coating which is based on the principles of heat reflection, and 2) a thermal insulation coating which is based on the principles of insulator of a low thermal conductivity coating. A heat reflective insulation coating is usually used to prevent the heat generated from radiation, for example, a heat reflective paint for buildings. The paint helps to reflect the sunlight so as to reduce solar thermal radiation coming into buildings, the temperature in the buildings therefore is not too high. The thermal insulation coating which is based on the principle of insulator of a coating is for applications that require a reduction or prevention of heat transfer such as insulation coatings for boilers, hot water storage tanks, furnaces, valves or heat transfer piping systems in petrochemical industry, refinery, etc. Nevertheless, most of the currently existing thermal insulation coating cannot be used in high-temperature applications.

CN 103881569 B discloses a composite coating for using as a thermal insulation and corrosion prevention for low-melting point metals or metal alloys. Said coating comprises three layers: a bottom layer which is a silane adhesive layer, an intermediate layer which is a polysilsesquioxane resin, and a top layer which is an inorganic silicone filler layer comprising silicon. However, such patent relates to a reflective coating.

US 2010/0126618 A1 discloses an insulated article comprising a first insulation region comprising a first polymer and first hollow ceramic microspheres and a second insulation region comprising a second polymer and second hollow ceramic microspheres. The thermal conductivity of the first insulation region is not more than the thermal conductivity of the first polymer. The volumetric heat capacity is in a range of 60-90% of the volumetric heat capacity of the first polymer. The thermal conductivity of the second insulation region is not more than 90% of the thermal conductivity of the second polymer. The volumetric heat capacity is less than 60-90% of the volumetric heat capacity of the second polymer. Said insulated article is suitably used with the submarine oil pipeline which must be exposed to sea water and a temperature of lower than 10° C. However, said insulated article is not intended for high-temperature applications and provides a relatively high thermal conductivity.

CN 102304966 A discloses an outer wall coating system with heat-insulation function for a cement wall comprising a cement layer, a primer layer, an intermediate layer and a topcoat layer. The coating according to this patent provides flexibility and low water absorption rate and prevents cracking of the coating layer of common buildings. However, such patent focuses on a wall coating system for buildings whose application temperature is not too high.

Therefore, the present invention is intended to develop a thermal insulation coating that is suitable for high temperature applications, capable of adhering well to a surface, environmentally friendly, as well as providing high thermal reduction and low thermal conductivity.

### SUMMARY OF THE INVENTION

The present invention relates to a thermal insulation coating comprising at least two layers of coating, wherein a composition of the first layer comprises a silicone-based binder and a hollow glass microsphere, a composition of the second layer comprises an acrylic polymer and a hollow glass microsphere.

The object of the present invention is to provide a thermal insulation coating that is suitable for high-temperature applications, capable of adhering to a surface effectively, environmentally friendly, as well as providing high thermal reduction and low thermal conductivity.

### BRIEF DESCRIPTION OF THE DRAWINGS

FIG. 1 shows results of the salt spray test for the examples of the invention and the comparative examples.

FIG. 2 shows results of the thermal cyclic corrosion test for the examples of the invention and the comparative examples.

### DETAILED DESCRIPTION

### Definitions

Technical or scientific terms used herein have the definitions as understood by those skilled in the art, unless otherwise specified.

Any tools, equipment, methods or chemicals mentioned herein refer to the tools, equipment, methods or chemicals that are commonly practiced or used by those skilled in the art, unless expressively specified as special or specific tools, equipment, methods or chemicals for the present invention.

Singular nouns or singular pronouns, when used with the term “comprise(s)” in the claims or specification, shall mean “one” and shall also encompass “one or more”, “at least one” and “one or more than one”.

Throughout this application, the term “about” is used to indicate that any values appeared or shown herein may be varied or deviated. Such variation or deviation may be caused by the errors of the equipment or methods used to determine the values or by the person who uses the equipment or performs such methods.

The aspects of the present invention will be shown hereinafter for illustrative purpose only and are not intended to limit the scope of the invention.

The present invention relates to a thermal insulation coating for a metal surface comprising at least two layers of coating, wherein
a composition of the first layer comprises a silicone-based binder and a hollow glass microsphere.
a composition of the second layer comprises an acrylic polymer and a hollow glass microsphere.

The composition of the first layer is aimed at lowering the temperature of a coated material surface having a temperature over 90° C. and the second layer is aimed at enhancing the strength of the thermal insulation coating and preventing cracking of the first layer, therefore enabling the thermal insulation coating according to the invention to be used in high temperature applications, reduce the heat effectively and have a mechanical strength.

Preferably, the silicone-based binder is a waterborne silicone emulsion.

Preferably, the acrylic polymer is a highly elastic acrylic polymer.

In an aspect of the invention, the hollow glass microsphere in the composition of the first layer is in an amount ranging from 10-37% by weight of the total composition of the silicone-based binder and hollow glass microsphere, preferably in a range of 15-35% by weight of the total composition of the silicone-based binder and hollow glass microsphere, and the hollow glass microsphere in the composition of the second layer is in an amount ranging from 10-30% by weight of the total composition of the acrylic polymer and hollow glass microsphere.

In another aspect of the invention, the thermal insulation coating may further comprise an additional layer between the first and second layers, wherein the composition of said additional layer comprises an acrylic-silicate copolymer and a hollow glass microsphere. The hollow glass microsphere in the composition of the additional layer between the first and second layers is in an amount ranging from 10-35% by weight of the total composition of the acrylic-silicate copolymer and hollow glass microsphere, preferably in an amount ranging from 15-30% by weight of the total composition of the acrylic-silicate copolymer and hollow glass microsphere.

The acrylic-silicate copolymer may comprise an acrylic in a range of about 10-50% by weight of the acrylic-silicate copolymer, preferably may be in a range of about 15-40%, more preferably may be in a range of about 18-35% by weight of the acrylic-silicate copolymer.

In an aspect of the invention, the hollow glass microsphere has a density in a range of 0.05 to 0.6 g/cm³ as the density of the hollow glass microsphere within this range provides a good thermal resistance.

The hollow glass microsphere should possess a crush strength to be able to resist the forces applied in stirring or preparing the thermal insulation coating because if there is a crack while stirring, the thermal resistance property of the hollow glass microsphere will be lost. Preferably, the crush strength should be in a range of 2,000-12,000 pounds per square inch and the size of the hollow glass microsphere is in a range of 90-125 microns.

In another aspect of the invention, the composition of the first layer, the composition of the second layer or the additional layer between the first and second layers of the thermal insulation coating may further comprise a solvent.

In an aspect of the invention, the solvent can be selected from water, alcohol or a combination thereof, preferably water to make the thermal insulation coating environmentally friendly. The solvent is in an amount ranging from 10-25% by weight of the composition of each layer.

In an aspect of the invention, the thermal insulation coating further comprises a dispersing agent, an anti-rust agent, a film former, a thickener, a defoamer or a combination thereof in an amount ranging from 0.1-25% of the composition of each layer.

The dispersing agent allows the hollow glass microsphere to disperse well in the composition of each layer of the thermal insulation coating. The dispersing agent may be selected from polycarboxylate acid, polycarboxylic acid, acrylic acid alkyl ester polymer, acrylate polymer, high alkalinity organic amine or a combination thereof.

The anti-rust agent may be selected from zinc phosphate tetrahydrate, zinc orthophosphate, zinc phosphate, aluminum dihydrogen phosphate, polyaniline/zinc/cerium nitrate, zinc tannate, magnesium tannate, zinc phosphate@aluminum tripolyphosphate (Zn₃(PO₄)₂@AlH₂P₃O₁₀), aluminum tripolyphosphate (AlH₂P₃O₁₀.2H₂O), zinc oxide or a combination thereof.

The film former may be selected from Texanol, 2,2,4-trimethyl-1,3-pentanediol monoisobutyrate, alkyds, vinyl acrylic, vinyl acetate/ethylene, polyurethane, polyester, melamine resin, epoxy, silane, siloxane, oil or a combination thereof.

The thickener may be selected from hydrophobic modified polyurethane solution, methacrylic acid, acrylate ester, polyethyleneglycol distearate, cellulose derivative or a combination thereof.

The defoamer may be selected from hydrophobic silica dispersion in mineral oil, polyacrylamide, polyethylene glycol, polypropylene glycol copolymer or a combination thereof.

Moreover, the thermal insulation coating may further comprise a biocide to inhibit the occurrence of bacteria or fungi and/or a fire retardant.

The biocide may be selected from 2-n-octyl-4-isothiazolin-3-one, 1-chloronaphthalene, [[[1-methyl-2-(5-methyl-3-oxazolidinyl)ethoxy]methoxy]methoxy]-methanol or a combination thereof.

The fire retardant may be selected from a compound containing phosphorus or magnesium. The fire retardant may be selected from tris(tribromoneopentyl)phosphate, magnesium calcium carbonate or a combination thereof.

In another aspect of the invention, the thermal insulation coating according to the invention has the thickness of the first layer in a range of 0.5-30.0 mm and the second layer in a range of 0.1-20.0 mm, preferably the thickness of the first layer is in a range of 1.0-2.0 mm and the second layer in a range of 0.2-1.0 mm.

The thickness of the additional layer between the first and second layers is in a range of 0.1-30.0 mm, preferably in a range of 0.1-20.0 mm.

However, the suitability of the thickness can be varied, depending on the requirement and application, for example, in case there is a need to increase the insulation, the thickness of the first layer or the additional layer between the first and second layers may be increased.

The present invention also includes the use of the thermal insulation coating for coating a surface of metals, woods, plastics, tiles, cements or fiber cements.

The present invention also relates to a method for applying the thermal insulation coating according to the invention comprising the following steps:
(1) providing the thermal insulation coating according to the invention;
(2) providing a substrate; and
(3) applying the thermal insulation coating from step (1) to the substrate from step (2).

The method for applying the thermal insulation coating comprises brush coating, spraying, dipping or rolling.

The present invention also relates to an article coated with the thermal insulation coating.

### EXAMPLES

### Determination of an Appropriate Amount of the Hollow Glass Microsphere

A carbon steel substrate was coated with a coating comprising 70 g of waterborne silicone emulsion, 10 g of water, and 10, 20, 25 and 40 g of hollow glass microsphere to determine an appropriate amount of the hollow glass microsphere.

The test was performed by placing the samples coated with the afore-mentioned thermal insulation coating at a thickness of 3 mm on a hotplate with a temperature of about 205° C. for 30 minutes. Then, a thermocouple was used to measure the temperature at the coating surface to determine the difference between the hotplate temperature and the coating surface temperature.

The amount of the hollow glass microsphere affects the thermal conductivity; the high amount will cause a lower thermal conductivity. The samples with the hollow glass microsphere in an amount of 10, 20, 25 and 40 g gave a temperature difference of 61, 72, 73 and 83° C., respectively. However, adding an excessive amount of the hollow glass microsphere, e.g. 40 g or about 33% by weight, will result in a failure to form a film by brush coating or spraying.

### Preparation of the Thermal Insulation Coating of the First Layer

The thermal insulation coating of the first layer was prepared by mixing 37.5% by weight waterborne silicone emulsion, 15% by weight hollow glass microsphere, 6% by weight acrylate polymer dispersing agent, 1.5% by weight hydrophobic silica dispersion in mineral oil, 8.5% by weight a mixture of aluminum tripolyphosphate and zinc oxide, and 31.5% by weight water at room temperature using a stirrer until they are homogeneous.

### Preparation of the Thermal Insulation Coating of the Additional Layer Between the First and Second Layers

The thermal insulation coating of the additional layer between the first and second layers was prepared by mixing 58% by weight acrylic-silicate copolymer, 20% by weigh hollow glass microsphere, 1.7% by weight Texanol, 2.8% by weight hydrophobic silica dispersion in mineral oil, 1.7% by weight acrylate polymer dispersing agent, and 15.8% by weight water at room temperature using a stirrer until they are homogeneous.

### Preparation of the Thermal Insulation Coating of the Second Layer

The thermal insulation coating of the second layer was prepared by mixing 87% by weight liquid acrylic polymer, 12% by weight hollow glass microsphere, 1% by weight acrylate polymer dispersing agent at room temperature using a stirrer until they are homogeneous.

### Comparative Thermal Insulation Coating

The comparative thermal insulation coating is commercially available. A comparative example 1 comprises ceramic, silica, and water-based acrylic. A comparative example 2 comprises respirable cristobalite, quartz, hydro-NM-oxide and water-based epoxy.

Preparation of Examples Coated with the Thermal Insulation Coating

A carbon steel substrate was respectively coated with the first layer, the additional layer and the second layer of the thermal insulation coating according to the invention by brush coating at different thicknesses as shown in Table 1.

For the comparative examples, the carbon steel substrate was coated with a comparative thermal insulation coating by brush coating at different thicknesses according to Table 2.

The substrates coated with the thermal insulation coating according to the invention and the comparative thermal insulation coating were subjected to a thermal reduction and thermal conductivity test, ASTM D7984; weather acceleration test, ASTM G-154, ASTM B117, ASTM G85/D5894; thermal resistance test, ASTM D2485, ASTM G189, and ISO 20340; salt spray test, ASTM B117; and thermal cyclic corrosion test.

### Thermal Reduction and Thermal Conductivity Tests

The thermal reduction test was performed by heating the substrate coated with the thermal insulation coating at different thicknesses using the hotplate at the substrate's bottom side which was not coated at a temperature of 200° C. for 30 minutes. Then, the thermocouple was used to measure the temperature at the coating surface. The test result is shown in Table 1 and 2.

The thermal conductivity test was performed using the C-Therm TCi, C-Therm Technology at a temperature of 32° C. The test result is shown in Table 1 and 2.

Table 1 shows the thicknesses, thermal reduction and thermal conductivity of the examples.

| | Example | Example | Example | Example | Example | Example |
|---|---|---|---|---|---|---|
| | 1 | 2 | 3 | 4 | 5 | 6 |
| 1^{st} layer thickness (mm) | 1 | 1 | 1 | 2 | 2 | 2 |
| Additional layer thickness | 1 | 2 | 3 | 1 | 2 | 3 |
| (mm) | | | | | | |
| 2^{nd} layer thickness (mm) | 0.5 | 0.5 | 0.5 | 0.5 | 0.5 | 0.5 |

Thermal reduction

| | | | | | | |
|---|---|---|---|---|---|---|
| Difference between surface | 92.2 | 98.7 | 107.1 | 97.8 | 107.9 | 115.5 |
| temperature and hotplate | | | | | | |
| temperature (° C.) | | | | | | |

Thermal conductivity

| | |
|---|---|
| 1^{st} layer conductivity | 53-56 |
| (milliwatt/meter-Kelvin) | |
| Additional layer conductivity | 52-55 |
| (milliwatt/meter-Kelvin) | |
| 2^{nd} layer conductivity | 82-87 |
| (milliwatt/meter-Kelvin) | |

Table 2 shows the thicknesses, thermal reduction and thermal conductivity of the comparative examples.

| | | | | | | Comparative | |
|---|---|---|---|---|---|---|---|
| | | | | | | thermal | |
| | Comparative thermal insulation | | | | | insulation | |
| | coating 1 | | | | | coating 2 | |
| Thermal insulation | 1 | 2 | 3 | 4 | 5 | 1 | 2 |
| coating thickness | | | | | | | |
| (mm) | | | | | | | |

Thermal reduction

| | | | | | | | |
|---|---|---|---|---|---|---|---|
| Difference between | 66 | 74.7 | 81.7 | 88.9 | 99.7 | 57.4 | 74.9 |
| surface temperature | | | | | | | |
| and hotplate | | | | | | | |
| temperature (° C.) | | | | | | | |

Thermal conductivity

| | | |
|---|---|---|
| Thermal conductivity | 74-75 | 79-81 |
| (milliwatt/meter- | | |
| Kelvin) | | |

### Weather Acceleration Test

The weather acceleration test was performed using the QUV ACCELERATED WEATHERING TESTER, Q-lab, USA, according to ASTM D154 standard. The test was carried out in six cycles, each cycle lasted seven days. One cycle is estimated to equivalent to the actual time period of 1 year and 6 months. Each cycle consisted of an alternating exposure of condensation at 50° C. for 4 hours and an exposure to UVB of 313 nm at a temperature of 60° C. for 4 hours. The test result shows that the examples according to the invention passed the test without detachment or formation of rust.

### Test on Thermal Reduction and Resistance to Temperatures Above 200° C.

The test result of the thermal insulation coating according to the invention at temperatures above 200° C. is shown in Table 3. The decrease in temperature is based on the thickness of the thermal insulation coating. For example, the difference between the surface temperature and hotplate temperature of Example 3 and Example 5, which have the total thickness of 4.5 mm, is not significantly different. In addition, it was found that the increased thickness of the thermal insulation coating resulted in a greater difference between the surface temperature and hotplate temperature. Moreover, it was found that, at a temperature of 350° C. there was no crack or detachment of the thermal insulation coating according to the invention.

Table 3 shows the thermal reduction at different temperatures.

| | Difference between surface temperature and | | | |
|---|---|---|---|---|
| Hotplate | hotplate temperature (° C.) | | | |
| temperature | Example 2 | Example 3 | Example 5 | Example 6 |
| 200° C. | 99 | 108 | 115 | 115.5 |
| 250° C. | 122 | 125 | 129 | 133 |
| 300° C. | 145 | 151 | 153 | 162 |
| 350° C. | 177 | 191 | 196 | 201 |

### Salt Spray Test

The test was performed in accordance with ASTM B117 standard by spraying a saline solution at a concentration of 5% by weight on the samples at a temperature of 35° C. for 30 days or 6 cycles. One cycle of test lasted 5 days, for 8 hours each day which is estimated to equivalent to the actual time period of 1 year and 6 months. The test result shows that all six thermal insulation coating examples according to the invention remained adhered well to the metal surface as exemplified in FIG. 1, whereas the comparative example 2 started to detach and upon removal of the coating the rust was found in a wide area on the substrate surface.

### Thermal Cyclic Corrosion Test

The test consisted of heating the examples having the thermal insulation coating according to the invention at 230° C. for 8 hours. The temperature was then decreased to a room temperature for 1 hour and to −18° C. for 14 hours before being increased to a room temperature. The test was carried out in 45 cycles in total. Each cycle of test illustrated actual application conditions of the thermal insulation coating such as applying the coating to a reactor wherein the reactor is shutdown or there is a heat flux in the reactor. The test result shows that all six thermal insulation coating examples according to the invention remained adhered well to the metal surface, as exemplified in FIG. 2, whereas the comparative example 1 showed a detachment of the coating from the substrate since day 2 of the test and the comparative example 2 showed a crack of the coating since day 2 of the test.

### BEST MODE OF THE INVENTION

Best mode of the invention is as described in the detailed description of the invention.

1. A thermal insulation coating comprising at least two layers of coating, wherein
a composition of the first layer comprises a silicone-based binder and a hollow glass microsphere,
a composition of the second layer comprises an acrylic polymer and a hollow glass microsphere.

2. The thermal insulation coating according to claim 1, wherein the silicone-based binder is a waterborne silicone emulsion.

3. The thermal insulation coating according to claim 1, wherein the hollow glass microsphere in the composition of the first layer is in an amount ranging from 10-37% by weight of the total composition of the silicone-based binder and hollow glass microsphere.

4. The thermal insulation coating according to claim 3, wherein the hollow glass microsphere in the composition of the first layer is in an amount ranging from 15-35% by weight of the total composition of the silicone-based binder and hollow glass microsphere.

5. The thermal insulation coating according to claim 1, wherein the hollow glass microsphere in the composition of the second layer is in an amount ranging from 10-30% by weight of the total composition of the acrylic polymer and hollow glass microsphere.

6. The thermal insulation coating according to claim 1, further comprising an additional layer between the first and second layers, wherein a composition of said additional layer comprises an acrylic-silicate copolymer and a hollow glass microsphere.

7. The thermal insulation coating according to claim 6, wherein the hollow glass microsphere in the composition of the additional layer between the first and second layers is in an amount ranging from 10-35% by weight of the total composition of the acrylic-silicate copolymer and hollow glass microsphere.

8. The thermal insulation coating according to claim 7, wherein the hollow glass microsphere in the composition of the additional layer between the first and second layers is in an amount ranging from 15-30% by weight of the total composition of the acrylic-silicate copolymer and hollow glass microsphere.

9. The thermal insulation coating according to claim 1, wherein the hollow glass microsphere has a density ranging from 0.05 to 0.6 g/cm³.

10. The thermal insulation coating according to claim 6, wherein the compositions of the first layer, the second layer or the additional layer between the first and second layers of the thermal insulation coating further comprises a solvent.

11. The thermal insulation coating according to claim 10, wherein the solvent is selected from water, alcohol or a combination thereof.

12. The thermal insulation coating according to claim 11, wherein the solvent is water.

13. The thermal insulation coating according to claim 1, further comprising a dispersing agent, an anti-rust agent, a film former, a thickener, a defoamer or a combination thereof.

14. The thermal insulation coating according to claim 13, wherein the dispersing agent, anti-rust agent, film former, thickener, defoamer or combination thereof are in an amount ranging from 0.1-25% of the composition of each layer.

15. The thermal insulation coating according to claim 1, wherein a thickness of the first layer is in a range of 0.5-30.0 mm and of the second layer is in a range of 0.1-20.0 mm.

16. The thermal insulation coating according to claim 1, wherein the thickness of the first layer is in a range of 1.0-2.0 mm and of the second layer is in a range of 0.2-1.0 mm.

17. The thermal insulation coating according to claim 6, wherein a thickness of the additional layer between the first and second layers is in a range of 0.1-30.0 mm.

18. The thermal insulation coating according to claim 17, wherein the thickness of the additional layer between the first and second layers is in a range of 0.1-20.0 mm.

19. A method comprising applying the thermal insulation coating according to claim 1 to a surface of metals, woods, plastics, tiles, cements or fiber cements.

20. A method for applying the thermal insulation coating according to claim 1, comprising the following steps:
(1) providing the thermal insulation coating;
(2) providing a substrate; and
(3) applying the thermal insulation coating from step (1) to the substrate from step (2).

21. The method for applying the thermal insulation coating according to claim 19 comprising brush coating, spraying, dipping or rolling.

22. An article coated with the thermal insulation coating according to claim 1.
